(19) United States
(12) Patent Application Publication
(10) Pub. No.: US 2018/0344093 A1
(43) Pub. Date: Dec. 6, 2018

(54) ROLLING MULTI-USE FOOD PROCESSOR AND METHODS TO USE THE SAME

(71) Applicant: Lifetime Brands, Inc., Garden City, NY (US)

(72) Inventors: Matt Krus, Seattle, WA (US); Josh Stewart, Edmonds, WA (US)

(21) Appl. No.: 15/991,814

(22) Filed: May 29, 2018

Related U.S. Application Data
(60) Provisional application No. 62/513,849, filed on Jun. 1, 2017.

(51) Int. Cl. A47J 43/25

(52) U.S. Cl. CPC A47J 43/255

(57) ABSTRACT

A food processor can include a body having a container portion and a food processing drum that is rotatably moveable relative to the body in a first rotary direction and a second rotary direction. The food processing drum can have a first food processing feature that causes a first food processing effect and a second food processing feature that causes a second food processing effect which is different from the first food processing effect. Rotation of the food processing drum in the first rotary direction can cause the first food processing effect and rotation of the food processing drum in the second rotary direction can cause the second food processing effect. Related methods are also provided.

### BACKGROUND

### Technical Field

The present disclosure is generally related to kitchenware, and more particularly, to a device for processing a food item, such as for grating, grinding, mincing, or slicing food products.

### Description of the Related Art

Devices used to grate, grind, mince, or chop or otherwise process food items or ingredients are typically limited in their functionalities. For example, some devices tend to offer functionality for grating food products only, which results in users having to use a separate device for other functions, such as slicing. Moreover, even devices that may offer multiple functionalities tend to have complex structures with multiple moving parts, such as gears, blades, etc. Such devices not only increase cost of manufacturing, but are also difficult to use and control for consumers. For example, typical food processing devices include hand-crank mechanisms, while others require users to manually grate, grind, etc., by applying and moving the food products repeatedly over processing surfaces. Such devices require users to expend energy that otherwise could be conserved and used for other functions. Accordingly, it is desirable to have food processing devices that are compact, cost-efficient to manufacture, multi-functional, and that provide simplicity and ease of use for consumers.

### BRIEF SUMMARY

The various implementations of food processors and related methods described herein provide multi-functional food processors having robust, compact, and efficient form factors. Moreover, the various implementations of food processors described herein enable cost-efficient manufacturing and provide simplicity of ease for users.

For example, in one non-limiting implementation, a food processor can be summarized and include a body having a container portion and a food processing drum that is rotatably moveable relative to the body in a first rotary direction and a second rotary direction. The food processing drum can have a first food processing feature that, in operation, causes a first food processing effect and a second food processing feature that, in operation, causes a second food processing effect which is different from the first food processing effect. Rotation of the food processing drum in the first rotary direction can cause the first food processing effect and rotation of the food processing drum in the second rotary direction can cause the second food processing effect.

For example, in another non-limiting implementation, a method of processing a food item using a food processor can be summarized as including positioning the food item in a container portion of a food processor body; rotating a food processing drum of the food processor in a first rotary direction to cause a first food processing effect; and rotating the food processing drum of the food processor in a second rotary direction to cause a second food processing effect.

### BRIEF DESCRIPTION OF THE SEVERAL VIEWS OF THE DRAWINGS

FIG. 1 is perspective view of a food processor, according to one example implementation.

FIG. 2 is an exploded view of the food processor of FIG. 1.

FIG. 3 is a side view of a side shell element of the food processor of FIG. 1, according to one example implementation.

FIG. 4 is a perspective view of a lower body of the food processor of FIG. 1, according to one example implementation.

FIG. 5 is a perspective view of a biasing assembly of the food processor of FIG. 1, according to one example implementation.

FIG. 6 is a perspective view of a food processing drum of the food processor of FIG. 1, according to one example implementation.

FIG. 7 is a cross-sectional view of the food processor of FIG. 1, taken along lines 7-7.

FIG. 8 is cross-sectional view of the food processor of FIG. 1, taken along lines 8-8.

FIG. 9 is a cross-sectional view of the food processor of FIG. 1, taken along lines 9-9.

### DETAILED DESCRIPTION

In the following description, certain specific details are set forth in order to provide a thorough understanding of various disclosed implementations. One skilled in the relevant art will recognize that implementations may be practiced without one or more of these specific details. In other instances, well-known structures and devices associated with food processing devices and related apparatuses, systems, and methods may not be shown or described in detail to avoid unnecessarily obscuring descriptions of the implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

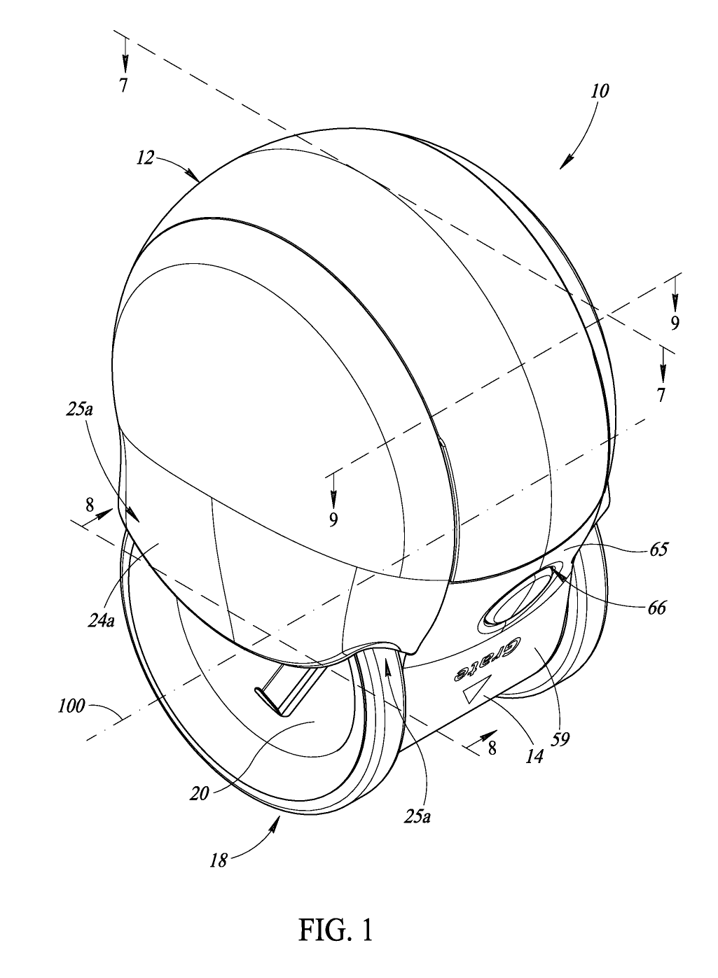

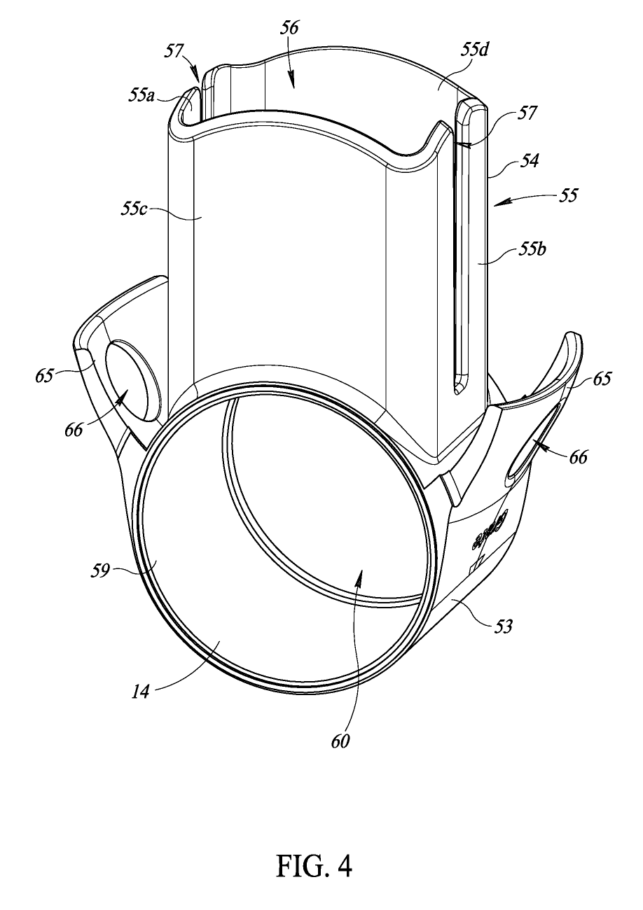

FIGS. 1 through 9 illustrate a food processor 10, according to one example, non-limiting implementation. The food processor 10 is generally operable to process food items, such as garlic or garlic clove, onions, cheese, etc., to produce a wide variety of desired food process effects or results, such as grated, grinded, minced, or sliced food items. Although for the sake of clarity of illustration and description, one or more of the desired food process effects are referred to heretofore, for example, grating and/or slicing, other food process effects are contemplated to be within the scope of the disclosed subject matter. In particular, the food processor 10 is generally operable to cause a wide variety of food processing effects by rolling the food processor 10 on a working surface.

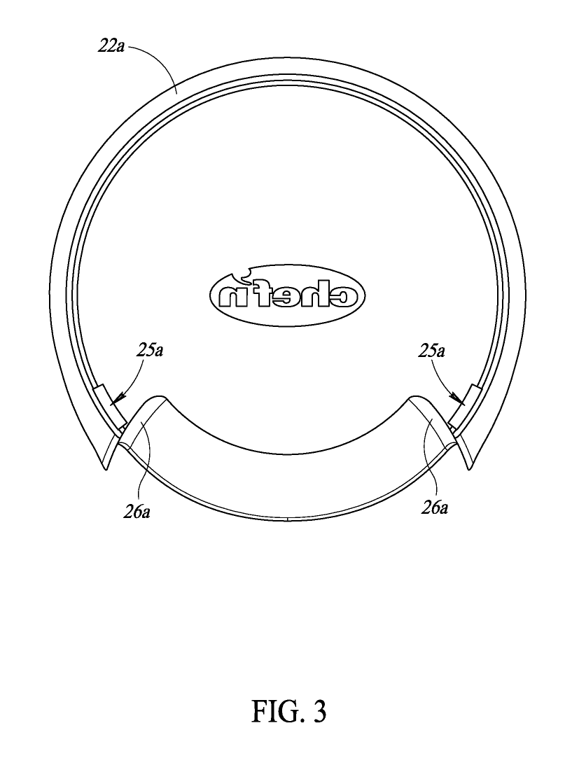

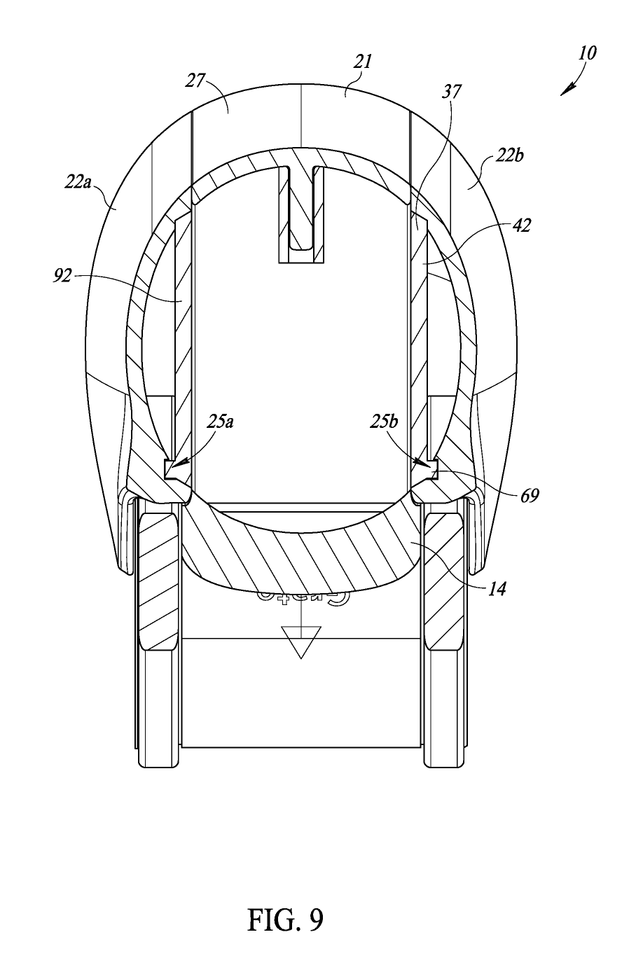

The food processor 10 includes an upper body assembly 12, a lower body 14, a biasing assembly 16, a roller assembly 18, and a food processing drum 20. The upper body assembly 12 includes a lid element 21 and a pair of side shell elements 22a, 22b. The side shell elements 22a, 22b are mirror image of each other. Each side shell element 22a, 22b has a corresponding main body 23a, 23b that has a substantially hemispherical shape with a flap portion 24a, 24b extending from a lower portion of the main body 23a, 23b. Proximal to lower ends of the corresponding side shell elements 22a, 22b, a pair of grooves 25a, 25b are disposed in the corresponding side shell elements 22a, 22b, which partially extend through an internal surface of the main body 23a, 23b of each side shell element 22a, 22b, as illustrated in FIGS. 3 and 9, for example. Each flap portion 24a, 24b has a lower surface with a generally arcuate profile, and the flap portions 24a, 24b having a pair of end portions 26a, 26b adjacent to opposing ends of the lower surface. Each end portion 26a, 26b is sized and shaped to be positioned adjacent the roller assembly 18. The end portions 26a, 26b overlie at least portions of the roller assembly 18 to cover and protect debris from entering internal regions or areas of the food processor 10.

The lid element 21 has a lid element main body 27 with a substantially arcuate, U-shaped profile having an external lid surface 28, an internal lid surface 29, and opposing internal side surfaces 30. Each internal side surface 30 is sized and shaped to couple the lid element main body 27 to corresponding side surfaces of the side shell elements 22a, 22b. The lid element main body 27 can be fixedly coupled to the side shell elements 22a, 22b via adhesives, welds, or other structures. In some implementations, the lid element main body 27 can be removably coupled to the side shell elements 22a, 22b via fasteners, or other snap-fit devices, such as pegs, posts received in corresponding apertures. Proximal to terminal ends, the lid element main body 27 includes corresponding recesses 31 that partially extend through the external lid surface 28 of the lid element main body 27 to define connector elements 32. As described in more detail below, the connector elements 32 are sized and shaped to removably couple the upper body assembly 12 to the lower body 14.

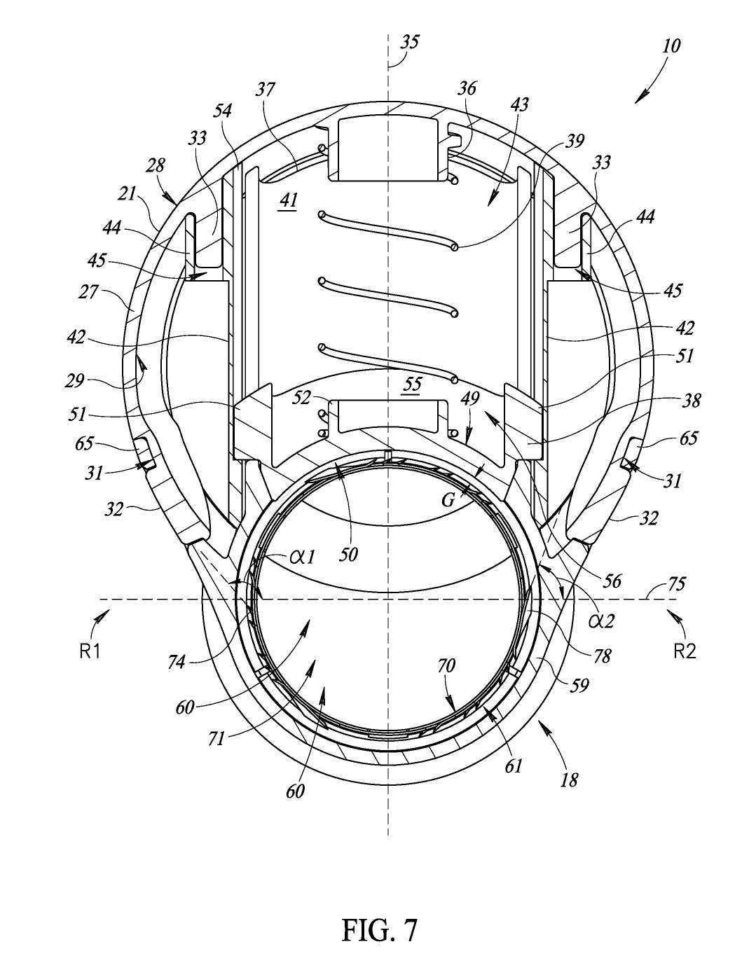

As illustrated with particular specificity in FIG. 7, the lid element main body 27 includes a pair of posts 33 that protrude outwardly from the internal lid surface 29 and are equally spaced apart relative to a vertical central axis 35 of the food processor 10. The posts 33 are sized and shaped to couple the lid element 21 to the biasing assembly 16, as described in more detail below. Protruding outwardly from the internal lid surface 29, the lid element main body 27 includes a first shaft element 36. The first shaft element 36 is also sized and shaped to couple the lid element 21 to the biasing assembly 16, as described in more detail below.

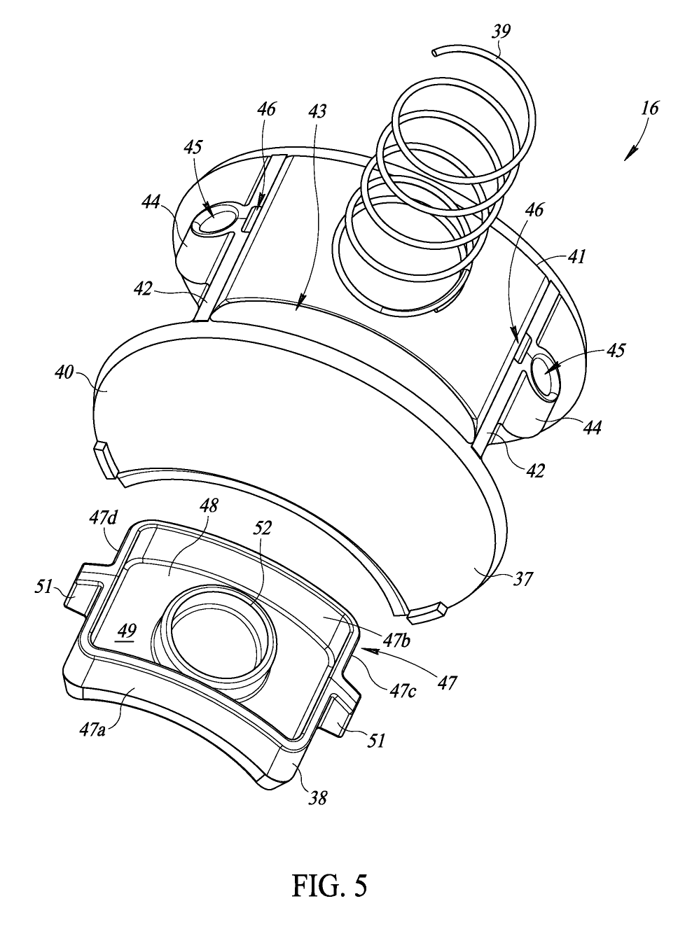

As illustrated with particular specificity in a perspective via of the biasing assembly 16 in FIG. 5, the biasing assembly 16 includes a housing 37, a pusher element 38, and a biasing device 39. The housing 37 includes a front wall 40 and an opposing rear wall 41, and a pair of opposing side walls 42. The front wall 40, the rear wall 41, and the pair of side walls 42 are coupled to each other to form an enclosed perimeter of the housing 37 and define a receiving region 43. The front wall 40, the rear wall 41, and the pair of side walls 42 can be individually coupled to each other via welds, adhesives, fasteners, or other coupling structures, or can be integrally formed as a monolithic structure. The receiving region 43 is sized and shaped to at least partially receive the pusher element 38 and the biasing device 39. Each side wall 42 includes a shaft connector element 44 protruding outwardly from an external surface of the side wall 42. The shaft connector element 44 includes a connecting aperture 45 which extends through a body of the shaft connector element 44. The connecting aperture 45 is sized and shaped to coupleably receive the posts 33 of the lid element main body 27. In this manner, when the lid element 21 is coupled to the biasing assembly 16, the posts 33 of the lid element main body 27 are coupled to the connecting apertures 45 of the side walls 42 of the housing 37. Each side wall 42 also includes a tab recess 46 that partially extends inwardly through an internal surface of the side wall 42. The tab recess 46 is sized and shaped to slideably receive the pusher element 38.

As described above, the receiving region 43 is sized and shaped to at least partially receive the pusher element 38, the biasing device 39, and a portion of the lower body 14. In particular, the pusher element 38 includes peripheral walls 47a, 47b, 47c, 47d (collectively referred to herein as peripheral walls 47) with a lower base element 48 that extends between the peripheral walls 47. The lower base element 48 includes an internal surface 49 and an external surface 50, which define a substantially arcuate profile as illustrated with particular specificity in FIG. 7, for example. The arcuate profile is constructed to facilitate compressing a wide variety of food items when contact is made therewith. For example, in some implementations, the pusher element 38 can be made of resilient materials, e.g., metals, plastics, etc., that can be flexible and/or elastically deform when contact is made with food items having a wide variety of shapes or forms, such as onions, garlic or garlic clove, potatoes, cheese in block forms, etc. In other implementations, the pusher element 38 can be made from materials that are more rigid. Protruding from a pair of side peripheral walls 47c, 47d are a pair of tab elements 51, which are sized and shaped to slideably couple the pusher element 38 to the housing 37. In particular, each tab element 51 is slideably received in the corresponding tab recess 46 of the housing 37, which allows the pusher element 38 to slideably move between different positions as the biasing device 39 applies biasing forces to urge the pusher element 38 toward the lower body 14.

As illustrated with particular specificity in FIGS. 5 and 7, the lower base element 48 includes a second shaft element 52 that protrudes outwardly from an internal surface of the lower base element 48. The second shaft element 52 disposed in the pusher element 38 and first shaft element 36 disposed in the lid element main body 27 are sized and shaped to coupleably receive the biasing device 39, e.g., a spring. In particular, one end of the biasing device 39 is coupled to the first shaft element 36 of the lid element main body 27 and another end of the biasing device 39 is coupled to the second shaft element 52 of the pusher element 38.

The lower body 14 includes a roller receiving portion 53 and a container portion 54. The container portion 54 includes container peripheral walls 55a, 55b, 55c, 55d (collectively referred to herein as container peripheral walls 55) which collectively define a food processing region 56. Each side container peripheral wall 55a, 55d includes a container tab recess 57 that extends through the side container peripheral wall 55a, 55d. The container tab recess 57 is sized and shaped to slideably receive the corresponding tab elements 51 of the pusher element 38 as the biasing device 39 slideably moves the pusher element 38 between different positions. In particular, the container tab recesses 57 disposed in the lower body 14 allow the upper body assembly 12, along with the biasing assembly 16, to be removed from the lower body 14 via slideable movement of the tab elements 51 of the pusher element 38 through the container tab recesses 57 to provide access to the food processing region 56. Again, as described above, the receiving region 43 of the housing 37 is sized and shaped to receive a portion of the lower body 14. Thus, when the upper body assembly 12 is coupled to the lower body 14, the container portion 54 of the lower body 14 surrounds the peripheral walls 55 of the pusher element 38, and is encompassed or surrounded by the front wall 40, rear wall 41, and the side walls 42 of the housing 37. As illustrated with particular specificity in FIG. 9, each side wall 42 of the housing 37 includes a shell connecting flange 69, which is sized and shaped to be coupleably received by the grooves 25a, 25b disposed in the side shell elements 22a, 22b to couple the biasing assembly 16 to the side shell elements 22a, 22b.

The roller receiving portion 53 of the lower body 14 includes a drum portion 59 which is substantially cylindrically shaped, with a drum aperture 60 extending through a body of the drum portion 59. The drum aperture 60 is sized and shaped to receive the food processing drum 20. In particular, when the food processing drum 20 is received through the drum aperture 60, an outer surface 61 of the food processing drum 20 is positioned between the external surface 50 of the lower base element 48 of the pusher element 38, and spaced apart to define a gap G. In this manner, when the food item is positioned in the container portion 54 within the food processing region 56, the food item is positioned between the external surface 50 of the lower base element 48 of the pusher element 38 and the outer surface 61 of the food processing drum 20, with the gap G being variable based at least in part on a structure of the food item and the biasing force of the biasing device 39 that urges the pusher element 38 toward the food item. The roller receiving portion 53 also includes a lower body coupling flange 63 which extends outwardly from an interior surface of a body of the roller receiving portion 55. The lower body coupling flange 63 is sized and shaped to couple the lower body 14 to the roller assembly 18, as described in more detail below.

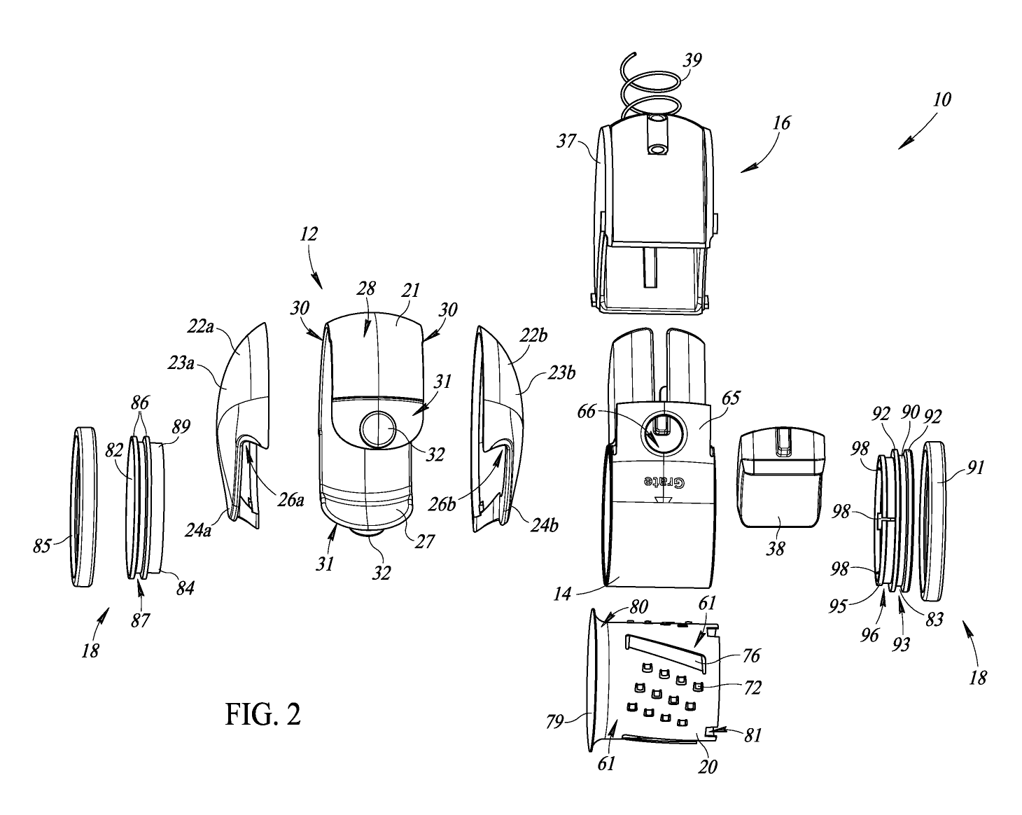

As illustrated with particular specificity in FIGS. 2, 4, and 7, the lower body 14 includes a pair of lower body tabs 65 that extend outwardly at an angular orientation relative to the vertical central axis 35 of the food processor 10, such that a contour of each lower body tab 65 substantially matches the arcuate, U-shaped profile of the lid element main body 27. In particular, each lower body tab 65 is a mirror image of the other relative to the vertical central axis 35 of the food processor 10. Each lower body tab 65 includes a connecting aperture 66 that extends through a body of the lower body tab 65. The connecting aperture 66 is sized and shaped to removably coupleably receive the connector elements 32 of the lid element 21. Thus, when the lid element 21 is removably coupled to the lower body 14 via the connector elements 32, each lower body tab 65 is seated over the corresponding recesses 31 of the lid element main body 27, where the contour of the lower body tab 65 substantially matches the arcuate, U-shaped profile of the lid element main body 27 to provide a substantially continuous profile of the upper portion of the food processor 10. Again, the lid element 21 and the lower body 14 can be made of resilient materials, e.g., metals, plastics, etc., that can be flexible and/or elastically deform when the lid element 21 is being coupled to the lower body 14.

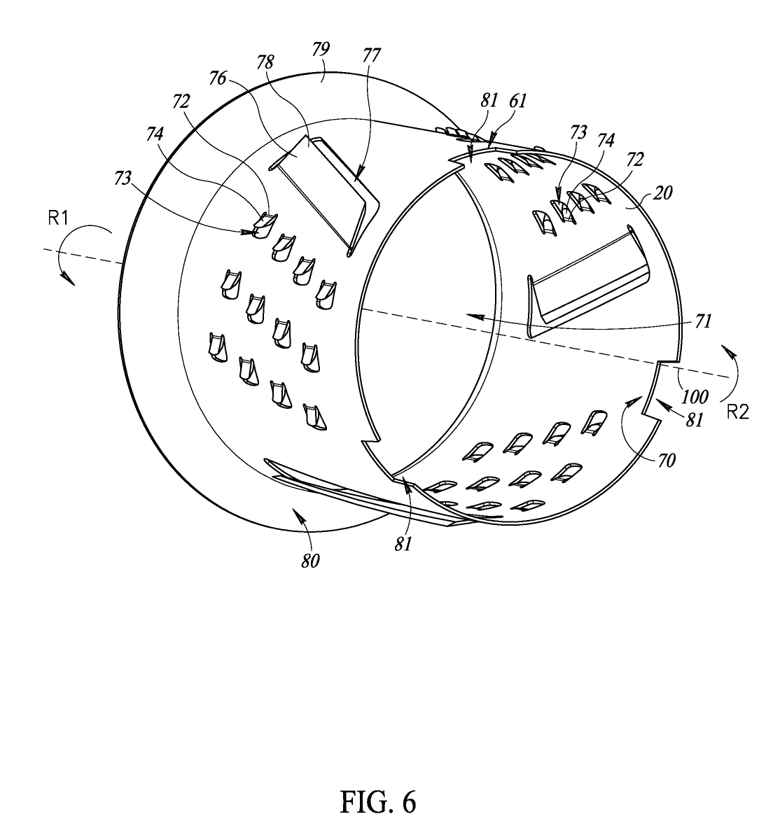

As described above, the food processing drum 20 is received in the drum portion 59 of the lower body 14. In particular, the food processing drum 20 is received in the drum portion 59 of the lower body 14 such that the food processing drum 20 is rotatably moveable relative to the lower body 14 about a pivot axis 100. The food processing drum 20 has a substantially cylindrical shape defined by the outer surface 61, an interior surface 70, and a food receiving aperture 71. As illustrated with particular specificity in FIGS. 6 and 7, the food processing drum 20 includes a plurality of grating features 72. Each grating feature 72 includes a grating cavity 73 and a grating blade 74 that protrudes outwardly relative to the outer surface 61 of the food processing drum 20. In particular, as illustrated in FIG. 7, each grating blade 74 extends angularly relative to a horizontal central axis 75 of the food processing drum 20 at a first angular orientation α1. Thus, when a food item contacts the outer surface 61 of the food processing drum 20 and is compressed thereon via the external surface 50 of the lower base element 48 of the pusher element 38, rotation of the food processing drum 20 at a first rotary direction R1 causes the grating blades 74 to process the food item, e.g., grate, grind, mince, etc., and the processed food item can move through the grating cavities 73 of the grating features 72 toward the interior surface 70 of the food processing drum 20 in the food receiving aperture 71.

The food processing drum 20 also includes a plurality of slicing features 76. Each slicing feature 76 includes a slicing cavity 77 and a slicing blade 78. The slicing blade 78 protrudes outwardly relative to the outer surface 61 of the food processing drum 20. In particular, as illustrated in FIG. 7, each slicing blade 78 extends angularly relative to the horizontal central axis 75 of the food processing drum 20 at a second angular orientation α2. The second angular orientation α2 at which the slicing blade 78 extends, however, is substantially opposite to the first angular orientation α1 at which the grating blades 74 extend.

Thus, when a food item contacts the outer surface 61 of the food processing drum 20 and is compressed thereon via the external surface 50 of the lower base element 48 of the pusher element 38, rotation of the food processing drum 20 at the first rotary direction R1 does not cause the slicing feature 76 to process the food item, but only the grating features 72 are effectuated to cause grating, grinding, mincing, etc. However, when the food processing drum 20 rotates in a second rotary direction R2 which is opposite to the first rotary direction R1, the slicing features 76 are effectuated to process the food item, e.g., slice the food item, which processed food item can move through the slicing cavities 77 of the slicing features 76 toward the interior surface 70 of the food processing drum 20 in the food receiving aperture 71. Again, when the food processing drum 20 rotates in the second direction R2, the grating features 72 are not effectuated to cause grating, grinding, mincing, etc., of the food items via the grating features 72.

While in some implementations, the food processing drum 20 can include a pair of different food processing features, for example, grating features 72 and slicing features 76, in other implementations, the food processing drum 20 can include pair of food processing features that are configured to cause the same food processing effect during rotation of the food processing drum 20 in both rotary directions R1, R2. For example, in some implementations, the food processing drum 20 can include a plurality of first grating features 72 with grating blades 74 extending angularly relative to the horizontal central axis 75 of the food processing drum 20 at the first angular orientation α1 and a plurality of second grating features 72 with grating blades 74 extending angularly relative to the horizontal central axis 75 at the second angular orientation α2. In this manner, the food processing drum 20 can cause the same food processing effect when rotated in the first rotary direction R1 and the second rotary direction R2. Similarly, in some implementations, the food processing drum 20 can include a plurality of first a plurality of first slicing features 76 with slicing blades 78 extending angularly relative to the horizontal central axis 75 of the food processing drum 20 at the first angular orientation α1 and a plurality of second slicing features 76 with slicing blades 78 extending angularly relative to the horizontal central axis 75 at the second angular orientation α2. Again, in this manner, the food processing drum 20 can cause the same food processing effect when rotated in the first rotary direction R1 and the second rotary direction R2.

The food processing drum 20 is rotatably moveable relative to the lower body 14 in first and second rotary directions R1, R2. In particular, at one end, the food processing drum 20 includes a lip element 79 that protrudes radially and outwardly from the outer surface 61 of the food processing drum 20 to define a rim receiving region 80. The rim receiving region 80 is sized and shaped to coupleably receive the roller assembly 18. Proximal to another end, the food processing drum 20 includes one or more notches 81 of the food processing drum 20. The one or more notches 81 are sized and shaped to facilitate coupling of the food processing drum 20 to the roller assembly 18.

The roller assembly 18 includes at least a first rolling member 82 and a second rolling member 83. The first and second rolling members 82, 83 can include any structure or shape suitable for rolling on a surface. At least one of the first rolling member 82 or the second rolling member 83 is coupled to the food processing drum 20 so that rotation of one of the first or second rolling members 82, 83 causes rotation of the food processing drum 20. In one implementation, the first rolling member 82 includes a first rim 84 and a first tire 85. The first rim 84 includes a pair of first flanges 86 spaced apart by a first groove 87. The first groove 87 is sized and shaped to coupleably receive the first tire 85. In particular, the first tire 85 includes a first tire flange 88 which extends outwardly and is sized and shaped to be coupleably received in the first groove 87. An end portion 89 of the first rim 84 is sized and shaped to be coupleably received in the rim receiving region 80. In this manner, in some implementations, when the food processing drum 20 is coupled to the first rolling member 82, rotation of the first rolling member 82 can cause rotation of the food processing drum 20.

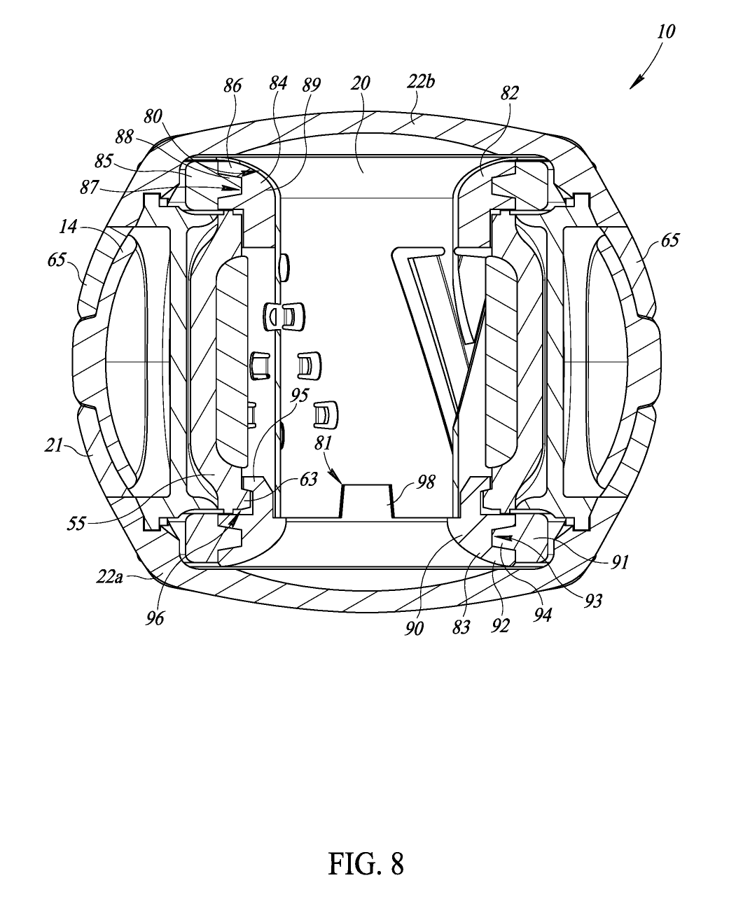

The second rolling member 83 also includes a second rim 90 and a second tire 91. The second rim 90 also includes a pair of second flanges 92 spaced apart by a second groove 93. The second groove 93 is sized and shaped to coupleably receive the second tire 91. In particular, the second tire 91 includes a second tire flange 94 which extends outwardly and is sized and shaped to be coupleably received in the second groove 93. The second rim 90 includes an end flange 95 spaced apart from an adjacent one of the pair of second flanges 92 defined by a third groove 96. The third groove 96 is sized and shaped to coupleably receive the lower body coupling flange 63, such that the roller assembly 18 is rotatably moveable relative to the lower body 14. As illustrated with particular specificity in FIGS. 2 and 8, the second rim 90 includes one or more drum tab elements 98. The one or more drum tab elements 98 are sized and shaped to couple the second rim 90 to the food processing drum 20. In particular, the one or more drum tab elements 98 are positioned in the one or more notches 81 such that peripheral wall surfaces defined by the one or more notches 81 abut or are adjacent to corresponding peripheral wall surfaces of the one or more drum tab elements 98. Thus, when the one or more drum tab elements 98 are received in the one or more notches 81 of the food processing drum 20, rotation of the second rolling member 83 causes rotation of the food processing drum 20. In this manner, the food processing drum 20 can rotate with the roller assembly 18 independently or relative to the lower body 14.

Thus, in operation, a user can decouple the upper body assembly 12 from the lower body 14; in particular, by decoupling the connector elements 32 of the upper body assembly 12 from the connecting apertures 66 of the lower body 14 to provide access to the food processing region 56 of the container portion 54 of the lower body. As described above, the upper body assembly 12, along with the biasing assembly 16, can be removed via slideable movement of the tab elements 51 of the pusher element 38 via the container tab recesses 57 disposed in the lower body 14. Thereafter, the user can position the food item in the food processing region 56 of the container portion 54, the food item being positioned on the outer surface 61 of the food processing drum 20. Once the food item is positioned in this manner, the user can couple the upper body assembly 12, along with the biasing assembly 16, to the lower body 14. The biasing device 39 is sized and shaped to urge the pusher element 38 toward the food item, the tab elements 51 of the pusher element 38 slideably moving toward the food item via tab recesses 46 of the housing 37 and container tab recesses 57 disposed in the lower body 14, such that the external surface 50 of the pusher element 38 compresses the food item against the outer surface 61 of the food processing drum 20. If a slicing effect is desired, the user can move the food processor 10 in one direction, causing rotation of the food processing drum 20 in the second rotary direction R2 to effectuate the slicing features 76. The processed food item can thereafter be received in the food receiving aperture 71 via the slicing cavities 77. If a grating effect is desired, the user can move the food processor in an opposite direction, causing rotation of the food processing drum 20 in the first rotary direction R1 to effectuate the grating features 72. The processed food item can thereafter be received in the food receiving aperture 71 via the grating cavities 73.

Moreover, the various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A food processor, comprising:
a body having a container portion; and
a food processing drum that is rotatably moveable relative to the body in a first rotary direction and a second rotary direction, the food processing drum having a first food processing feature that, in operation, causes a first food processing effect and a second food processing feature that, in operation, causes a second food processing effect which is different from the first food processing effect, rotation of the food processing drum in the first rotary direction causing the first food processing effect and rotation of the food processing drum in the second rotary direction causing the second food processing effect.

2. The food processor of claim 1 wherein the first food processing effect includes slicing a food item.

3. The food processor of claim 1 wherein the second food processing effect includes grating a food item.

4. The food processor of claim 1 wherein the body includes an upper body assembly and a lower body removably coupled to the upper body assembly, the lower body having a drum aperture that is sized and shaped to receive the food processing drum.

5. The food processor of claim 4 wherein the lower body includes a connecting aperture and the upper body assembly includes a connector element, the connecting aperture sized and shaped to removably coupleably receive the connector element.

6. The food processor of claim 5 wherein the connecting aperture is disposed in a lower body tab, the lower body tab extending in an angular orientation relative to a vertical central axis of the food processor.

7. The food processor of claim 1, further comprising:
a biasing assembly having a pusher element spaced apart from an external surface of the food processing drum to define a region that receives a food item, the biasing assembly having a biasing device that urges the pusher element toward the external surface of the food processing drum.

8. The food processor of claim 7 wherein the biasing assembly further comprises a housing that is sized and shaped to receive the pusher element.

9. The food processor of claim 8 wherein an upper body assembly of the body includes a first shaft element and the pusher element includes a second shaft element, the biasing device having a first end coupled to the first shaft element and a second end coupled to the second shaft element.

10. The food processor of claim 9 wherein the pusher element is slideably moveable in the housing.

11. The food processor of claim 1 wherein the first food processing feature includes a slicing blade that is oriented at a first angle relative to a central axis of the food processing drum, and the second food processing feature includes a grating blade that is oriented at a second angle relative to the central axis of the food processing drum.

12. The food processor of claim 11 wherein the first angle is substantially opposite to the second angle relative to the central axis.

13. The food processor of claim 11 wherein the first food processing feature includes a slicing cavity and the second food processing feature includes a grating cavity, the slicing cavity and the grating cavity providing a respective passageway for a processed food item to move toward an interior surface of the food processing drum.

14. The food processor of claim 1, further comprising:
a pair of rolling members, at least one of the pair of rolling members coupled to the food processing drum, rotation of the at least one of the pair of rolling members causing rotation of the food processing drum.

15. A method of processing a food item using a food processor, the method comprising:
positioning the food item in a container portion of a food processor body;
rotating a food processing drum of the food processor in a first rotary direction to cause a first food processing effect; and
rotating the food processing drum of the food processor in a second rotary direction to cause a second food processing effect.

16. The method of claim 15 wherein the first food processing effect includes slicing the food item.

17. The method of claim 15 wherein the second food processing effect includes grating the food item.

18. The method of claim 15 wherein positioning the food item includes removably uncoupling an upper body assembly of the food processor body from a lower body of the food processor body.

19. The method of claim 15, further comprising:
urging the food item toward an external surface of the food processing drum via a biasing assembly.

20. The method of claim 19 wherein urging the food item includes slideably moving a pusher element of the biasing assembly via a biasing device toward the food item.
